(19) United States
(12) Patent Application Publication
(10) Pub. No.: US 2005/0171944 A1
(43) Pub. Date: Aug. 4, 2005

(54) Translator database

(76) Inventor: Robert D. Palmquist, Faribault, MN (US)

Correspondence Address: SHUMAKER & SIEFFERT, P. A., 8425 SEASONS PARKWAY, SUITE 105, ST. PAUL, MN, 55125, US

(21) Appl. No.: 11/012,890

(22) Filed: Dec. 15, 2004

Related U.S. Application Data
(60) Provisional application No. 60/529,802, filed on Dec. 16, 2003.

(51) Int. Cl. G06F 7/00

(52) U.S. Cl. 707/4

(57) ABSTRACT

In one embodiment, the invention is directed to a system including a database that supports a plurality of client translation devices. Although each client translation device may operate as a stand-alone translator, each device may establish a communication with a server that can keep the client translation device up-to-date. The server is coupled to a database that supports the client translation devices by dynamically adding, subtracting and changing translation entries, thereby evolving as the language evolves. The server communicates one or more translation entries in the database to the client translation devices.

This application claims the benefit of U.S. Provisional Application Ser. No. 60/529,802, filed Dec. 16, 2003, the entire content of which is incorporated herein by reference.

### STATEMENT REGARDING FEDERALLY SPONSORED RESEARCH OR DEVELOPMENT

This invention was made with Government support under Contract N00014-02-C-0122 awarded by the Office of Naval Research. The Government has certain rights in this invention.

### TECHNICAL FIELD

The invention relates to support of language translation.

### BACKGROUND

Many persons can benefit from a device that can translates a message in a source language into a target language. One need not be a traveler to a foreign land to enjoy the benefits of such a device. In some cosmopolitan regions of the United States, for example, it is not unusual to hear conversations in many different languages. In addition, immigration may bring to a community many individuals who do not speak English as a first language.

There are many circumstances in which an organization, such as a governmental unit or a private business, may desire to supply translation devices to its personnel for use. The translation devices may translate words and phrases from a source language to a target language. The translation devices may also supply the users with other information pertaining to the translation, such as information about pronunciation and usage.

An organization may be interested in translating words and phrases applicable to its particular area of focus. A private retailer, for example, may be interested in telling non-English speaking customers about a line of products or how credit can be arranged. A police department may be interested in having a device that can translate subject matter appropriate to law enforcement or emergencies. A medical facility may be especially interested in translation of health-related words and phrases. A military organization with personnel deployed abroad may be interested in having the personnel able to communicate with local residents.

### SUMMARY

In general, the invention is directed to a system including a database that supports a plurality of client translation devices. Although each client translation device may operate as a stand-alone translation device, it may be desirable for the words and phrases stored in the memory of the client translation device to be kept up-to-date. Languages are dynamic, with new terms being added on a continuing basis and other terms continually falling out of favor. The database supports the client translation devices by dynamically adding, subtracting and changing translation entries, evolving as the language evolves. A server, in communication with one or more client translation devices via a network, communicates one or more entries in the database to the client translation devices. Communication of translation entries to client translation devices keeps the words and phrases stored in the memories of the client translation devices, and other information pertaining to translation, current.

In one embodiment, the invention is directed to a system that includes a database, the database comprising at least one translation entry pertaining to at least one of a word and phrase in a source language and at least one translation of the word or phrase in a target language. The system also includes a server that communicates the translation entry to a client translation device, with the client translation device being configured to translate at least one of a word and a phrase from the source language to the target language.

In another embodiment, the invention is directed to a method that could be implemented by the server. The method includes establishing a communication interface with a client translation device, and selecting at least one translation entry from a database. The method also includes communicating the translation entry to the client translation device.

In a further embodiment, the invention presents a method that could be implemented by client translation device. The method includes establishing a communication interface with a server coupled to a database comprising at least one translation entry, and receiving the translation entry from the server. The invention further encompasses embodiments in which the client translation device generates a translation entry for inclusion in the database.

Further embodiments of the invention include computer-readable media containing instructions that cause a machine to carry out any of the above methods.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating a translation management system.

FIG. 2 is a sample screen shot illustrating examples of translation entries that may be stored in a database and communicated to one or more client translation devices.

FIG. 3 is a flowchart illustrating interactions between a server and one or more client translation devices according to embodiments of the invention.

### DETAILED DESCRIPTION

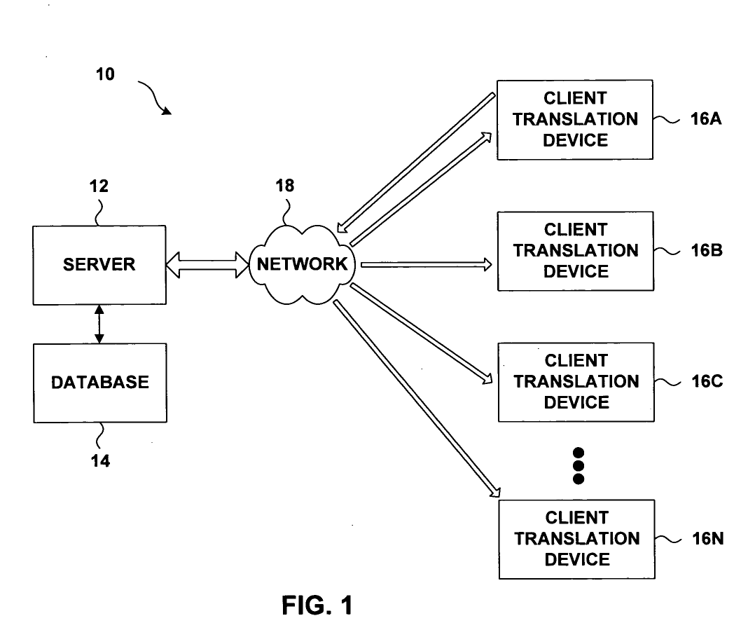

FIG. 1 is a block diagram illustrating a translation management system 10 in which a server 12 coupled to a translation database 14 communicates with client translation devices 16A-16N (hereafter 16) over a network 18 to manage data pertaining to language translation. More specifically, authorized client translation devices 16 interact with server 12 and translation database 14 via network 18, whereby server 12 communicates translation entries from database 14 to client translation devices 16, and client translation devices 16 receive the translation entries.

“Translation entries,” as used herein, is broadly defined as any data stored in database 14 pertaining to translation from a source language to a target language. Translation entries comprise words and/or phrases, including vocabulary, expressions, idioms, colloquialisms, slang, jargon, acronyms, and specialized words or phrases. The term “translation entries” also encompasses information about words or phrases, such as parts of speech, examples of usage, grammar, politeness level, and information about pronunciation. Translation entries may be entirely new or updated versions of previous translation entries. Translation entries may relate to any source or target languages.

Once client translation device 16 establishes an interface with server 12, client translation device 16 may initiate communication of one or more translation entries from database 14 by downloading translation entries from database 14. Server 12 may also initiate communication of translation entries to client translation device 16 when the interface is established, exporting translation entries to client translation device 16 without a specific request from client translation device 16. The invention encompasses embodiments in which server 12 initiates communication of translation entries to client translation device 16 as well as embodiments in which client translation device 16 initiates communication.

In addition, authorized client translation devices 16 may interact with server 12 and translation database 14 via network 18 to upload new translation entries to database 14. The invention supports a range of uploading authorization from client translation devices 16. In some embodiments of the invention, all client translation devices 16 may be granted freedom to upload translation entries. In other embodiments, a limited number of client translation devices 16 may be granted freedom to upload translation entries. In further embodiments, client translation devices 16 may not be permitted to upload translation entries at all.

Server 12 and translation database 14 typically comprise a server system and one or more associated data storage elements such as one or more hard disks. In some embodiments, translation management system 10 may include a plurality of servers. The invention is not limited to any particular server-database configuration.

Client translation device 16 may stand alone as a translation tool. Client translation device 16 may comprise any device that can translate a word or expression in a source language to a target language. Client translation device 16 may support any number of source or target languages. Different companies make commercially available translation programs for different languages, and client translation device 16 may support one or more such programs. Typical client translation devices 16 include a memory element that stores one or more translation engines, along with words and phrases and the associated translations in the source and target languages.

When translating phrases, a client translation device 16 may refer to phrases stored in memory before engaging the translation engine. Client translation device 16 may include one or more categories of phrases, and the categories may be arranged in a hierarchy. A law enforcement officer, for example, may have phrases categorized according to most frequently used expressions, emergency phrases and general expressions. Client translation device 16 may further support a search algorithm that matches, or attempts to match, a desired phrase to an expression already in memory.

With such a search capability, a law enforcement officer wishing to say “Get out of the car right now” may be able to find a similar expression already in memory that acceptably conveys the intended meaning, such as “Get out of the car now.” In some client translation devices 16, a user may specify that the device return matches that exceed a threshold level. Client translation devices 16 may present the user with phrases in memory that are a 92 percent match or better, for example, and ignore phrases that are below the 92 percent threshold.

In many cases, it is preferable for client translation device 16 to use existing expressions in memory rather than to engage the translation engine. In general, phrases in memory may be deemed more reliable and closer to the intended meaning than translations performed “from scratch” by the translation engine. Translation entries received by client translation device 16 from database 14 expand the number of phrases in the memory of client translation device 16, and therefore improve the reliability and accuracy of client translation device 16.

The translation engine can be configured to perform pre-translation processing, such as correcting spelling or grammar prior to translation. In addition, the translation engine may draw upon one or more dictionaries, which may be arranged in a hierarchy. In a military dictionary, for example, the term “click” may be identified as a measurement of distance, but in a general dictionary, the same term may be defined as a kind of a sound. Translation entries received by client translation device 16 from database 14 expand the dictionaries available to client translation device 16, and therefore improve the capability of client translation device 16.

Client translation device 16 may further support visual or audio interaction with a user. In other words, client translation device 16 includes any device that can receive a spoken and/or written message in a source language and can generate a written and/or audible translation of the message. The message and the translation can be presented in any fashion, including graphically, visually, in sign language, or in any other fashion. In some embodiments, client translation device 16 is a handheld device such as a personal digital assistant (PDA) or a cellular telephone. Other examples of client translation device 16 include a tablet PC, a camera, a desktop PC, and a kiosk.

In some embodiments of the invention, client translation devices 16 are not coupled to network 18 at all times. Client translation devices 16 may be portable or handheld devices that accompany a sales agent, law enforcement officer, medical care provider, or other user while the user goes about daily activities. From time to time, the user may couple client translation device 16 to network 18 and may receive new translation entries from database 14.

Network 18 may include any communication network. Network 18 may include, for example, a wireless telecommunication network such as a network implementing Bluetooth, a cellular telephone network, the public switched telephone network, an integrated digital services network, satellite network or the Internet, or any combination thereof. A user may couple client translation device 16 to network 18 via any interface, such as by placing client translation device 16 in a docking station or wirelessly connecting to network 18.

By interacting with translation database 14, users of client translation devices 16 can remain current with changes in source and target languages. A retailer that introduces a new product, for example, can include in database 14 translation entries pertaining to the new product, such as words and phrases that pertain to the name of the new product, its features, directions for usage, warnings, support information and so on. Server 12 may communicate such translation entries from database 14 to client translation devices 16, which receive the translation entries. Client translation devices 16 then can use the received translation entries when providing translations to users such as sales staff. As a result, client translation devices 16 provide the users with translations that are clearer and more customized than would be ordinarily be provided by the translation software operating on the client translation devices 16. The translations may be more appropriate to the product, and generally more useful to the user.

In FIG. 1, client translation devices 16 receive translation entries communicated by server 12. The received translation entries may be the same for all client translation devices 16. In some circumstances, however, the received translation entries may vary from one client translation device 16 to another. A first client translation device may have coupled to network 18 and established a communication interface with server 12 more recently than a second client translation device, for example, so the first client translation device may have already received translation entries that the second client translation device had not. As a result, the second client translation device may have more translation entries to receive than the first client translation device. The received translation entries may depend upon other factors as well, such authorizations afforded to different client translation devices 16 or user preferences for a particular client translation device 16.

One example of a user preference is to receive translation entries from a reliable source. As shown in FIG. 1, system 10 supports uploading of translation entries from individual users. In particular, the user of client translation device 16A is shown uploading one or more translation entries to server 12 and database 14 via network 18. The new translation entries may in turn be distributed to other users when server 12 communicates translation entries from database 14 to other client translation devices. In this way, multiple users share the information via a dynamically updated translation database.

The invention supports embodiments in which each client translation device 16 receives the same translation entries. The invention also supports embodiments in which individual client translation devices 16 can be customized to receive translation entries that differ from translation entries received by other client translation devices. For example, the invention supports embodiments in which users may choose to accept or disregard translation entries, depending upon factors such as the identity of the user who generated the translation entries, the subject matter of the translation entries, or the source or target languages. Translation entries that are accepted are stored in the memory element associated with client translation devices 16.

Returning to the example of a retailer's database that communicates translation entries pertaining to a new product, it is possible that the experience of one member of the sales staff may be of a benefit to other members of the sales staff. That user, who may have some experience with the source and target languages, may submit one or more translation entries to the database. The submitted translation entries may be identified with the user that submitted them. The invention supports embodiments in which other users, who receive the submitted translation entries, may exercise discretion as to whether to accept those translation entries as reliable or not. It may be generally known, for example, that translation entries generated by one user are reliable, but that translation entries generated by another user are not.

The invention also supports embodiments in which database 14 accepts translation entries from authorized users but not from other users. For example, the management or system administrator of a retailer may grant authorization to submit translation entries to individuals who are known to be familiar with the source and target languages, and may deny such authorization to other users. The invention further supports embodiments in which database 14 accepts no translation entries from authorized users via client translation devices 16, but accepts translation entries from a single authorized entity such as a system administrator or database manager.

The invention further supports techniques in which a user accepts or rejects translation entries as a function of content. In the illustrative case of a retailer, a user who sells apparel, for example, may choose not to accept new translation entries that pertain to automotive supplies. In some embodiments of the invention, database 14 may support one dictionary of words and phrases related to apparel, and a separate dictionary related to automotive supplies, and each user may choose to receive translation entries from selected dictionaries.

In another scenario, server 12 supports multiple source and target languages, and the user may choose not to accept translation entries for particular languages. In the case of retailer with multiple outlets, a user at one outlet may have a significant Spanish-speaking customer base, but few speakers of other languages. A user at this outlet may choose not to accept translation entries other than Spanish-English and English-Spanish translation entries.

In a further illustrative situation, users may be given the option to accept part of a single translation entry. A translation entry may include, for example, portion that supports text-to-text translation, a portion that includes pronunciation information, and one or more audio files. A user who works exclusively with text may prefer not to receive any information pertaining to audible translations, such as audio files or pronunciation guides. This user may therefore choose to accept part of a translation entry communicated by server 12 and may choose not to accept another part. The user stores in the local memory of the client translation device 16 those portions of the translation entry that the user deems useful.

The invention is not limited to the particular techniques described above. The invention supports other techniques for managing the database as well as managing the client translation devices.

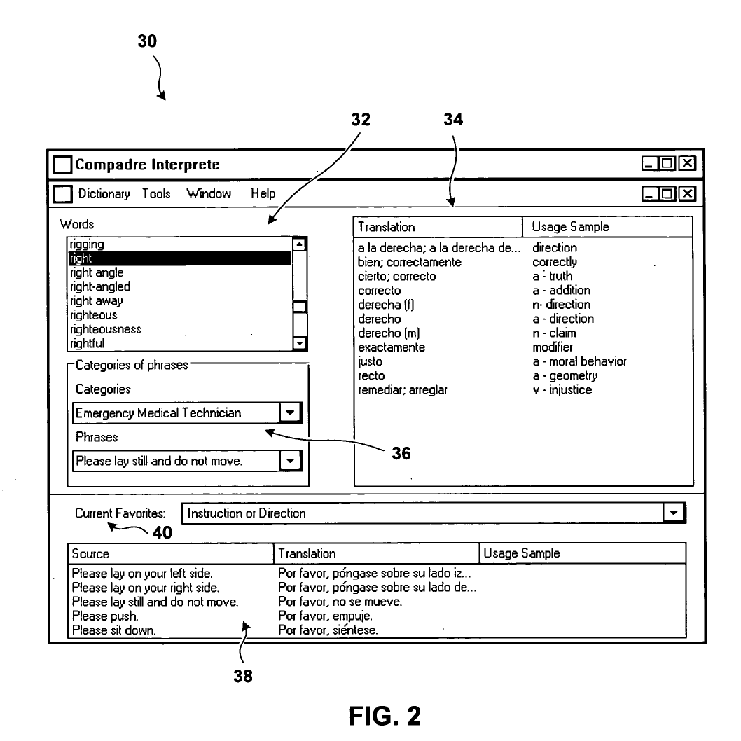

FIG. 2 is an exemplary screen shot 30 illustrating translation entries that client translation devices 16 may receive from database 14. Screen shot 30 may include information presented on a terminal coupled to server 12, and illustrates the kinds of translation entries that would be available to a system administrator or other manager of database 14. In the example of FIG. 2, the source language is English and the target language is Spanish.

As shown in FIG. 2, some of the translation entries are vocabulary terms 32. Vocabulary terms 32 include single-word terms such as “right” and “righteous” and multiword terms such as “right angle” and “right away.” Each vocabulary term has one or more associated translation 34. Many vocabulary terms may have multiple meanings. Accordingly, each term may have multiple translations 34. As shown in FIG. 2, the English word “right” has many possible translations in Spanish. The translations may be accompanied by a usage sample that can assist a user in selecting the correct Spanish term. Usage samples may specify parts of speech, synonyms, exemplary expressions, mnemonics, and so forth.

New translation entries may be added to the vocabulary, and may be communicated to client translation devices 16. A company that sells sporting goods, for example, may desire to add the adjective “right-handed” to its vocabulary. The company may further include usage samples to distinguish a “right-handed” person from a “right-handed” sporting good, the latter indicating a sporting good designed for use by a right-handed person. Vocabulary translation entries such as these may be shared by client translation devices that interact with the database.

Some of the translation entries pertain to categories of phrases 36. In the example of FIG. 2, the categories of phrases pertain to phrases useful for an emergency medical technician (EMT), but the invention supports any number of categories. Categories 36 may be thought of as dictionaries. A single database may support one dictionary for EMTs, for example, and a separate dictionary for law enforcement personnel. In some embodiments of the invention, phrases may be arranged in multiple dictionaries that focus upon particular endeavors.

Within each category of phrases useful for an EMT, the database includes phrases 38 that an EMT may employ in an emergency situation. The phrases may be organized into groups 40, such as “Instruction or Direction,” “Chest Pain,” “Patient Medical History,” and so forth.

Phrases 38 include expressions comprising collections of words. Translations for phrases as a whole often more accurately convey an intended meaning than translations of individual words that make up the phrases. In addition, phrases may include idiom or slang that give the phrase meaning beyond the meaning of the individual words in the phrase. An EMT asking a patient“How do you feel?” for example, is asking the patient for a general subjective assessment of his condition, not for an explanation as to how the patient uses his sense of touch.

Like a vocabulary term, a phrase may have one or more associated translations. The translations may be accompanied by a usage sample that can assist a user in selecting the correct Spanish phrase.

New translation entries may be added to the phrases, and server 12 may communicate the new translation entries to client translation devices 16. In the context of an EMT, for example, new phrases may pertain to particular examinations or therapies administered according to local health protocols. Phrase translation entries may be shared by client translation devices that interact with the database.

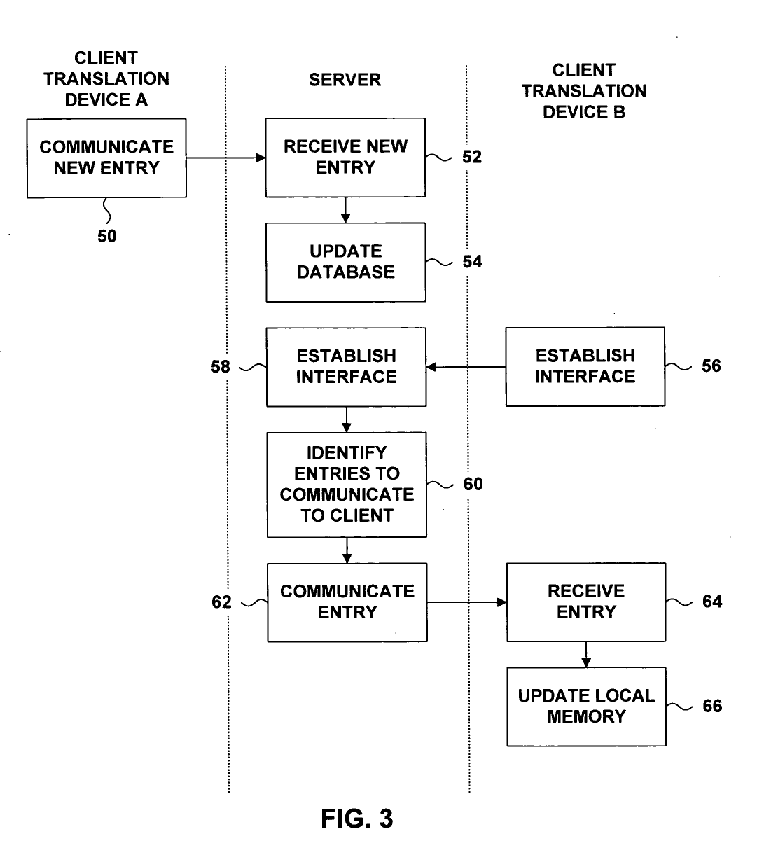

FIG. 3 is a flow diagram illustrating an example operation of system 10. A first user, after preparing a new translation entry, communicates or uploads the translation entry to server 12 (50). FIG. 3 shows the first user submitting the translation entry to server 12 with a client translation device 16, but the invention encompasses embodiments in which a translation entry is submitted to server 12 via other routes as well, such as by a system administrator or database manager. Server 12 receives the translation entry (52) and updates database 14 (54).

When a second client translation device 16 associated with a second user establishes contact with server 12 (56, 58), server 12 may determine whether there have been any new translation entries since the last time the second client translation device established an interface with the network (60). It is generally more efficient for server 12 to communicate entries to the client translation device that have not been previously communicated, rather than to communicate entries that the client translation device has already received. Accordingly, server 12 selects translation entries to be communicated to the client translation device.

Server 12 communicates the selected translation entries (62), which are received by the second client translation device (64). Communication (62) and reception (64) may be via export initiated by server 12, or via download initiated by client translation device 16, or any combination of both. In other words, server may initiate the communication of entry to client translation device 16, or server 12 may communicate the translation entry in response to a request from client translation device 16, or both.

The second client translation device may update its local memory to incorporate the received translation entries (66). As noted above, the invention supports giving the option to the second user to determine whether to accept the translation entries received from server 12. The second user may, for example, choose to store some translation entries in memory but not others.

The invention may offer one or more advantages. There are many endeavors in which multiple users benefit from a translation database that changes dynamically. The invention keeps the users up to date by providing a common database from which translation entries can be exported or downloaded. Multiple client translation devices can be synchronized, with each client translation device capable of having the most up-to-date information. Users within a company or governmental entity can share translation entries. Groups of entities that have a common purpose, such as private emergency response teams, may also share translation entries.

In addition, the database can support preferences that can benefit one or more users. Preferences include one or more favored options regarding system operation. One example of a preference is a mode of presentation of a message or a translation. For example one or more users may apply a preference that output be audible, using a male voice. Another example of a preference is an honorific setting, which pertains to the politeness or formality levels of the communication. Also, the invention supports “one to many” translation, in which translation entries in multiple target languages can be processed and presented substantially simultaneously.

Further, the invention supports any number and any kind of client translation device. One user may use personal computer as a client translation device for purposes of translating written documents. Another user may use a PDA as a client translation device for purposes of communicating with customers. A third user may use a cellular telephone with a built-in camera as a client translation device for the purposes translating information that appears on public signs. Any and all of these disparate users may interact with the server and database to receive the most current translation entries.

The invention supports a range of flexibility. One entity, such as a retailer, may give its sales staff considerable discretion to accept translation entries on the basis of language or content. Another entity, such as a military organization, may prefer that all users have uniform translation tools and may give users no discretion about what translation entries to accept.

Several embodiments of the invention have been described. Various modifications may be made without departing from the scope of the invention. For example, the invention includes embodiments in which the database is organized along lines different from those shown above. The invention also includes embodiments in which the server determines what translation entries will be communicated to a user as a function of source, language, content or other parameters.

Further, the invention includes some embodiments comprising any of a variety computer-readable media comprising instructions for causing a programmable processor, such as server 12 or a processor disposed in a client translation device 16, to carry out the techniques described herein. Such computer-readable media include, but are not limited to, magnetic and optical storage media, and read-only memory such as erasable programmable read-only memory or flash memory. These and other embodiments are within the scope of the following claims.

1. A system comprising:
a database comprising at least one translation entry pertaining to at least one of a word and phrase in a source language and at least one translation of the word or phrase in a target language; and
a server to communicate the translation entry to a client translation device, the client translation device configured to translate at least one of a word and a phrase from the source language to the target language.

2. The system of claim 1, wherein the translation entry comprises at least one of a vocabulary term, an expression, an idiom, a colloquialism, and an acronym.

3. The system of claim 1, wherein the translation entry comprises at least one of a part of speech, an example of usage, a politeness level and pronunciation information.

4. The system of claim 1, further comprising the client translation device.

5. The system of claim 1, further comprising a network to communicate the translation entry to the client translation device.

6. A method comprising:
establishing a communication interface with a client translation device;
selecting at least one translation entry from a database, the translation entry pertaining to at least one of a word and phrase in a source language and at least one translation of the word or phrase in a target language; and
communicating the translation entry to the client translation device.

7. The method of claim 6, wherein the client translation device is a first client translation device, the method further comprising receiving the translation entry from a second client translation device.

8. The method of claim 7, further comprising storing the received translation entry in the database.

9. The method of claim 6, further comprising initiating the communication of the translation entry to the client translation device.

10. The method of claim 6, wherein communicating the translation entry to the client translation device comprises responding to a request from the client translation device.

11. The method of claim 6, further comprising:
establishing a second communication interface with a second client translation device;
selecting at least one second translation entry from the database; and
communicating the second translation entry to the second client translation device.

12. A method comprising:
establishing a communication interface with a server coupled to a database comprising at least one translation entry pertaining to at least one of a word and phrase in a source language and at least one translation of the word or phrase in a target language; and
receiving the translation entry from the server.

13. The method of claim 12, further comprising generating a request for the entry.

14. The method of claim 12, further comprising storing at least a part of the translation entry in local memory.

15. The method of claim 12, wherein the translation entry is a first translation entry, the method further comprising uploading a second translation entry to the server.
